(19) United States
(12) Patent Application Publication
(10) Pub. No.: US 2025/0390839 A1
(43) Pub. Date: Dec. 25, 2025

(54) SYSTEMS AND METHODS FOR OPTIMIZING CATEGORY PLACEMENT FOR SPACES

(71) Applicant: Walmart Apollo, LLC, Bentonville, AR (US)

(72) Inventors: Soheyl Zehtabiyan, Frisco, TX (US); Mowen Lu, San Jose, CA (US); Deep Narayan Mishra, Sunnyvale, CA (US); Kowsalya Ganesan, San Jose, CA (US); Rishi Bhatia, Bentonville, AR (US); Daniel Robert Goldschmidt, Neosho, MO (US); Jiewen Wang, San Jose, CA (US); Gultekin Kuyzu, Kirkland, WA (US); Aniket Diliprao Misal, Irving, TX (US); Priyanka Surapaneni, Celina, TX (US); Ajay Kumar Boddepalli, Seattle, WA (US)

(21) Appl. No.: 19/242,548

(22) Filed: Jun. 18, 2025

Related U.S. Application Data
(60) Provisional application No. 63/662,221, filed on Jun. 20, 2024.

(51) Int. Cl. G06Q 10/087

(52) U.S. Cl. CPC G06Q 10/087

(57) ABSTRACT

Systems and methods for floorplan generation using models are disclosed. A system receives a request to generate a floorplan from a user device. The request includes a category placement parameter. The system also obtains a floorplan parameter from a database. The system determines, based on the category placement parameter and the floorplan parameter, the floorplan. The floorplan assigns categories to respective portions of a location represented by the floorplan. The system, in accordance with a determination that the floorplan satisfies an infeasibility criteria threshold, causes the user device to present an error notification that identifies an infeasibility error in at least one of the category placement parameter or the floorplan parameter, and requests, from the user device, at least one of an updated category placement parameter or an updated floorplan parameter.

### CROSS-REFERENCE TO RELATED APPLICATIONS

This application claims benefit to U.S. Provisional Appl. No. 63/662,221, filed Jun. 20, 2024, entitled “Systems And Methods For Optimizing Category Placement For Spaces,” the disclosure of which is incorporated herein by reference in its entirety.

### TECHNICAL FIELD

This application relates generally to a floorplan generation model, and more particularly, to a system for generating, presenting, and/or deploying floorplans.

### BACKGROUND

Some existing solutions for floorplan generation provide users with tools for manually drawing floorplans. The existing solutions allow for visualization of floorplans but do not recommend category placement and/or prepare floorplans. The process of manually preparing floorplans is time consuming requiring constant user inputs and feedback. As such, exiting solutions for floorplan generation and/or category reassignments place additional burdens and constraints on personnel (e.g., taking personnel away from their core tasks). Manual floorplan preparation increases cost and restricts the ability for personnel to respond quickly to demand fluctuations (such as holidays). Thus, manual floorplan planning and generation amounts to a significant negative financial impact.

Thus, there is a need for new solutions for preparing floorplans, detect errors in the generated floorplans, propose solutions for the errors, and/or presents the errors to users.

### SUMMARY

The system and methods disclosed herein provide solutions for preparing floorplans. In particular, the system and methods disclosed herein generate floorplans for a location, assign categories to fixtures within the location, detect errors in the generated floorplans, propose solutions for the errors, and/or presents the errors to users. For example, the system and methods disclosed prepare floorplans for assigning categories and/or category groups to different fixtures and/or aisles within a retail store. The system and methods disclosed herein reduce costs and improve efficiency by reducing the time needed to prepare floorplans and/or increase flexibility in adjusting floorplans by recommending floorplans, detecting errors in floorplans, and presenting options to users for finalizing floorplans. Additionally, the system and methods disclosed herein utilize less computation resources and require less iterations which allows for more complex requirements to be used in generating floorplans, reduces inefficiencies, and/or makes the floorplan generation model accessible. The system and methods disclosed herein allow for the evaluation of manual and/or automatically drawn floorplans.

In various embodiments, a system is disclosed. The system includes a non-transitory memory and a processor communicatively coupled to the non-transitory memory. The processor is configured to read a set of instructions to receive, from a user device, a request to generate a floorplan, the request including a category placement parameter. The processor is further configured to read a set of instructions to obtain, from a database, a floorplan parameter. The processor is further configured to read a set of instructions to determine, based on the category placement parameter and the floorplan parameter, the floorplan. The floorplan assigns categories to respective portions of a location represented by the floorplan. The processor is further configured to read a set of instructions to, in accordance with a determination that the floorplan satisfies an infeasibility criteria threshold, cause the user device to present an error notification that identifies an infeasibility error in at least one of the category placement parameter or the floorplan parameter and request, from the user device, at least one of an updated category placement parameter or an updated floorplan parameter.

In various embodiments, a computer-implemented method is disclosed. The computer-implemented method includes steps of receiving, from a user device, a request to generate a floorplan, the request including a category placement parameter. The method includes obtaining, from a database, a floorplan parameter. The method includes determining, based on the category placement parameter and the floorplan parameter, the floorplan. The floorplan assigns categories to respective portions of a location represented by the floorplan. The method includes, in accordance with a determination that the floorplan satisfies an infeasibility criteria threshold, causing the user device to present an error notification that identifies an infeasibility error in at least one of the category placement parameter or the floorplan parameter and requesting, from the user device, at least one of an updated category placement parameter or an updated floorplan parameter.

In various embodiments, a non-transitory computer readable medium having instructions stored thereon is disclosed. The instructions, when executed by at least one processor, cause at least one device to perform operations including receiving, from a user device, a request to generate a floorplan, the request including a category placement parameter. The instructions, when executed by the at least one processor, cause the at least one device to perform operations including obtaining, from a database, a floorplan parameter. The instructions, when executed by the at least one processor, cause the at least one device to perform operations including determining, based on the category placement parameter and the floorplan parameter, the floorplan. The floorplan assigns categories to respective portions of a location represented by the floorplan. The instructions, when executed by the at least one processor, cause the at least one device to perform operations including, in accordance with a determination that the floorplan satisfies an infeasibility criteria threshold, causing the user device to present an error notification that identifies an infeasibility error in at least one of the category placement parameter or the floorplan parameter and requesting, from the user device, at least one of an updated category placement parameter or an updated floorplan parameter.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to generate floorplans, in accordance with some embodiments;

FIG. 2 illustrates a computer system configured to implement one or more processes, in accordance with some embodiments;

FIG. 3 illustrates a floorplan generation system, in accordance with some embodiments;

FIG. 4 illustrates an example floorplan, in accordance with some embodiments;

FIG. 5 illustrates an example floorplan user interface for a floorplan generation system, in accordance with some embodiments; and

FIG. 6 is a flowchart illustrating a floorplan generation method, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for floorplan generation. In various embodiments, the methods and systems for floorplan generation provide a solution for a multi-objective combinatorial optimization problem (or category placement optimization problem). In various embodiments, the methods and systems for floorplan generation identify fixtures, fixture types, fixture placement, fixture dimensions and orientation, location (e.g., retail store, patio, etc.), location size, categories, category constraints, fixture preference, etc. and generate floorplans for the location. The generated floorplans group categories into super-categories called shops and places the categories within each shop coherently.

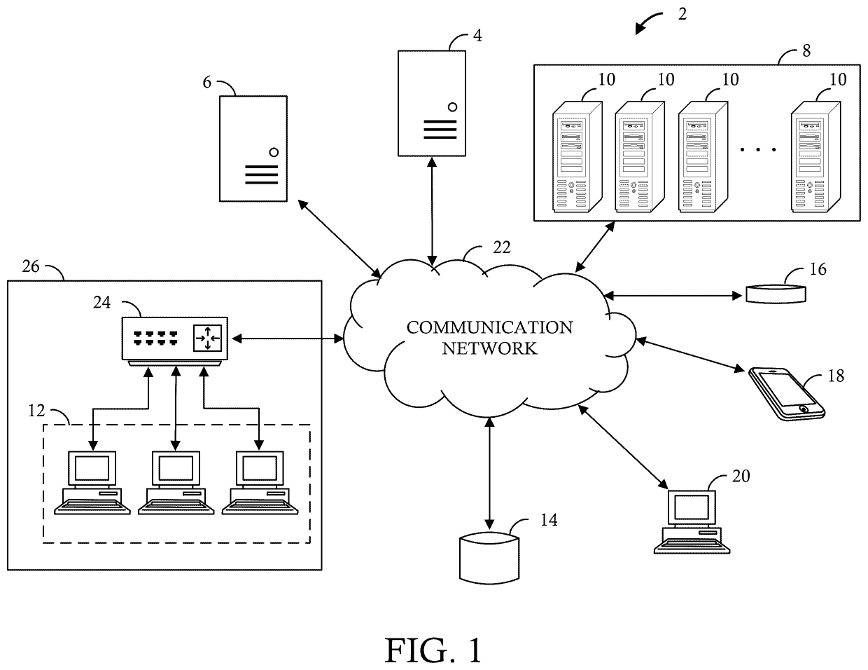

FIG. 1 illustrates a network environment 2 configured to generate floorplans, in accordance with some embodiments. The network environment 2 includes a plurality of devices or systems configured to communicate over one or more network channels, illustrated as a network cloud 22. For example, in various embodiments, the network environment 2 may include, but is not limited to, a floorplan generation computing device 4, a web server 6, a cloud-based engine 8 including one or more processing devices 10, a database 14, and/or one or more user computing devices 16, 18, 20 operatively coupled over the network 22. The floorplan generation computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the floorplan generation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the floorplan generation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the floorplan generation computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the floorplan generation computing device 4, for example. The workstation(s) 12 may communicate with the floorplan generation computing device 4 over the communication network 22. The workstation(s) 12 may send data to, and receive data from, the floorplan generation computing device 4. For example, the workstation(s) 12 may transmit data related to tracked operations performed at the physical location 26 to the floorplan generation computing device 4.

Although FIG. 1 illustrates three user computing devices 16, 18, 20, the network environment 2 may include any number of user computing devices 16, 18, 20. Similarly, the network environment 2 may include any number of the floorplan generation computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the floorplan generation computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser or programs operating on the user computing devices, perform various operations such as provide and/or define one or more category placement parameters, search one or more databases associated with a location for determining floorplan parameters, initiate one or more operations for generating a floorplan, review and distribute a generated floorplan, implement a generated floorplan, etc. The website may capture these activities as user session data, and transmit the user session data to the floorplan generation computing device 4 over the communication network 22. The website may also allow the user to interact with one or more of interface elements to perform specific operations, such as selecting one or more items for further processing.

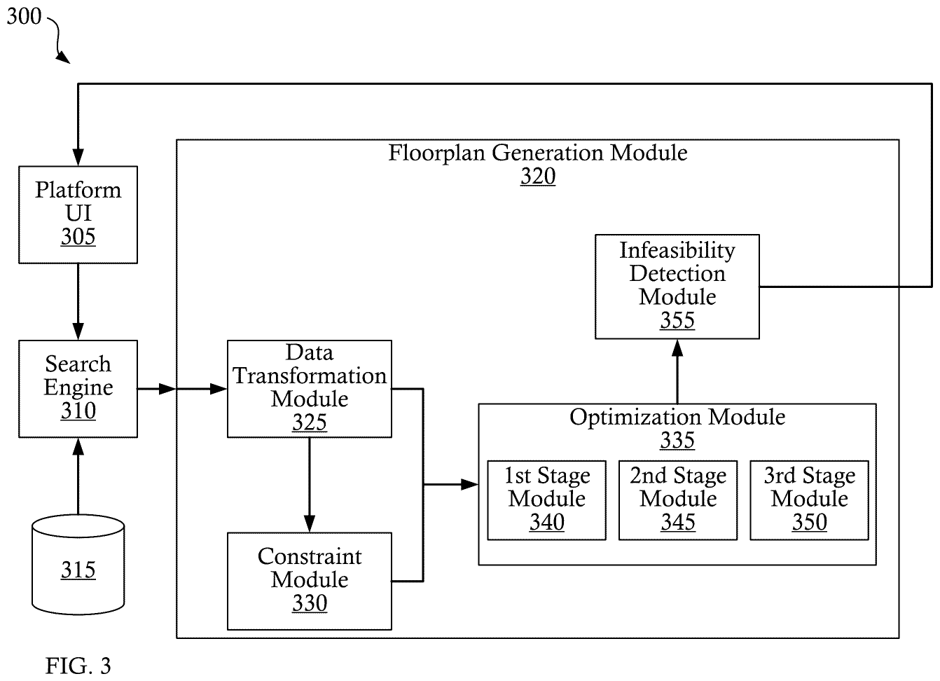

In some embodiments, the floorplan generation computing device 4 may execute one or more models, processes, or algorithms, such as a floor generation module 320 (FIG. 3) to receive and/or transform data, determine one or more floorplans based on the received and/or transformed data, floorplan feasibility detection, floorplan scoring, and/or perform other operations described below. The floorplan generation computing device 4 may transmit generated floorplans and related data to the web server 6 over the communication network 22, and the web server 6 may generate floorplans one or more databases, distribute the floorplan to one or more communicatively coupled devices, and/or perform one or more operations based on the generated floorplans.

The floorplan generation computing device 4 is further operable to communicate with the database 14 over the communication network 22. For example, the floorplan generation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the floorplan generation computing device 4, in some embodiments, the database 14 may be a local storage device, such as a hard drive, a non-volatile memory, or a USB stick. The floorplan generation computing device 4 may store interaction data received from the web server 6 in the database 14. The floorplan generation computing device 4 may also receive from the web server 6 user session data identifying events associated with browsing sessions, and may store the user session data in the database 14.

In some embodiments, the floorplan generation computing device 4 assigns one or more models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, the floorplan generation computing device 4 may generate one or more floorplans to be added to, distributed to, and/or stored in the database and/or communicatively coupled devices via the communication network 22.

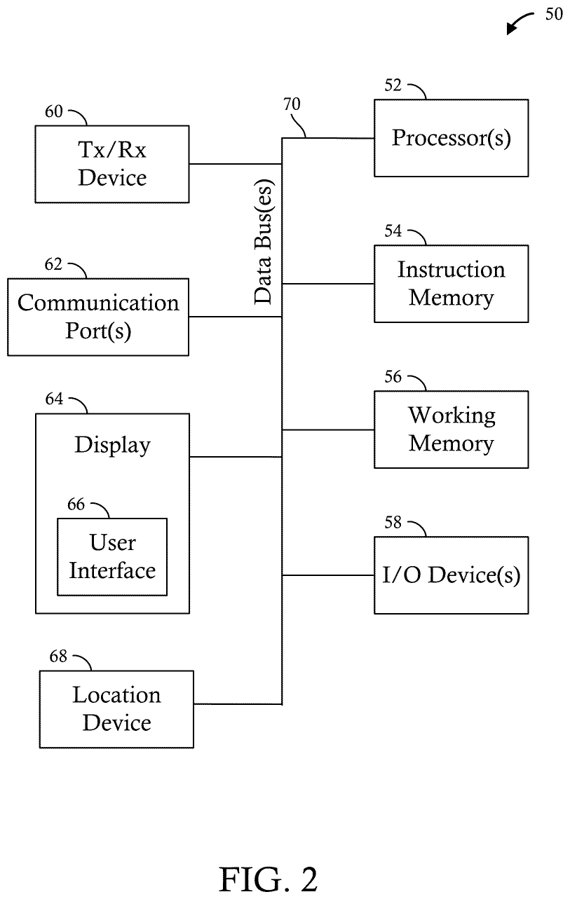

FIG. 2 illustrates a block diagram of a computing device 50, in accordance with some embodiments. In some embodiments, each of the floorplan generation computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generative floorplans (e.g., that optimizing category placement), as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NOSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with extracted attributes. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

FIG. 3 illustrates a floorplan generation system, in accordance with some embodiments. The floorplan generation system 300 is configured to generate one or more floorplans that optimize category placement. The floorplan generation system 300 includes a platform user interface (UI) 305, a search engine 310, a database 315, and a floorplan generation module 320. The floorplan generation module 320 includes a data transformation module 325, a constraint module 330, an optimization module 335 (including one or more modules, such as a first mixed integer linear program (MILP) (represented by MILP1 or a first stage module 340), a second MILP (represented by MILP2 or a second stage module 345), and a third MILP (represented by MILP3 or a third stage module 350)), and an infeasibility detection module 355.

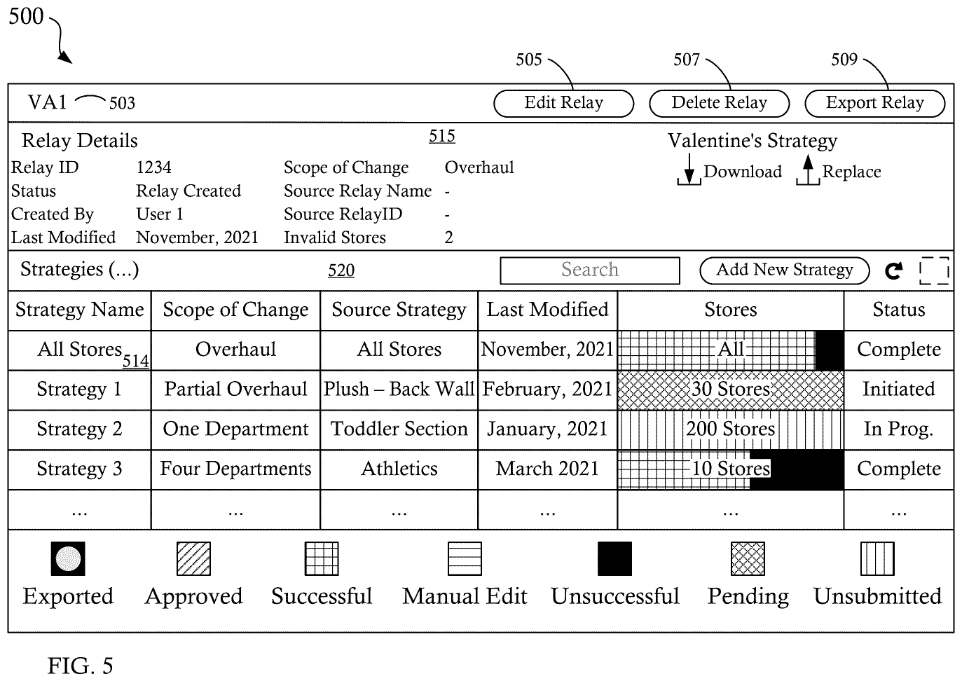

The floorplan generation system 300 is configured to generate floorplans for placing one or more categories (e.g., products, items, product types, item types, etc.) at respective portions of a location represented by the generated floorplans (e.g., a retail store, a theater, a garden, a warehouse, a home, an office, an open field, an open area, and/or other physical locations). The floorplan generation system 300 is configured to assign categories with pre-determined space requirements, fixture preferences, and/or fixture compatibilities to portions of a location (e.g., aisles, entrances, exits, etc.) and fixtures within a location. The assigned categories, category groups, and/or departments (e.g., groups of category groups) are presented in generated floorplans. In some embodiments, the generated floorplans provide a visual representation of a location, categories, category groups, and/or departments, as well as the assigned placement of the categories, category groups, and/or departments at portions of the location. In other words, the generated floorplans are configured to assign categories, category groups, and/or departments to portions of the location such that the location is easy to navigate (e.g., navigable such that a minimum number of turns (e.g., no turns, one turn, two turns, etc.) are needed by a person in reaching a category) and allow for categories to be easily located (e.g., visually apparent, disposed at expected locations, disposed adjacent to similar categories, etc.). In some embodiments, the floorplan generation system 300 utilizes numerous restrictions, guidelines, and metrics to generate the floorplans. In some embodiments, the floorplan generation system 300 resolves one or more conflicts between the numerous restrictions, guidelines, and metrics. The floorplans generated using the floorplan generation system 300 can be generated via relays (as shown in FIG. 5), which minimizes changes to existing floorplans and/or overhauls. Additionally, use of relays allows for floorplans for multiple locations to be generated remotely and/or at any communicatively coupled device.

The platform UI 305 is presented at a user device (e.g., one or more user computing devices 16, 18, 20 or other device described above in reference to FIG. 1). The platform UI 305 allows a user to provide, via the user device, a request to generate a floorplan. The floorplan generation request includes one or more category placement parameters. The category placement parameters are used to define one or more constraints for generating one or more floorplans. The category placement parameters include one or more of a category, a category constraint, a fixture constraint, a scope of change, an environmental constraint, a grouping constraint, a motion constraint, or a location constraint. The request to generate a floorplan can also include a predetermined location for which the floorplan is being generated.

The scope of change defines one or more objectives of a generated floorplan, such as an objective to minimize movement (compared to a baseline or starting floorplan), a scale of change (e.g., complete overhaul, partial overhaul, etc.), restricted movements (e.g., restricting movement of categories (e.g., anchoring selected categories to a baseline configuration)).

The fixture constraints include a preferred fixture type defining up to a predetermined number (e.g., 10, 15, etc.) of fixture types and/or fixture subtype combinations; predetermined number of supported fixture types; a fixture priority defining an order for placement of a category for a fixture type; fixture dimensions and orientation; fixture placement; etc.

The category constraints include a size constraint that defines ranges of heights, depths, widths, and weights of a category and/or a temperature constraint of a category (e.g., temperature to maintain the category in an ideal condition), each of which are used to ensure that a category fits within a location represented by a floorplan. The category constraints also include stacking constraints that define groupings of categories that stack on a fixture and define conditional stacking of categories, and sharing constraints that define groupings of categories that sit side by side on the same fixture.

The environmental constraints restrict placement of categories that require specific environmental concerns (e.g., shade, sunlight, etc.) to particular locations of the location and/or restrictions for placing categories behind and/or within columns if the category is allowed such placement.

The motion constrains are used to define one or more wraps and/or splits allowed for a floorplan (e.g., valley wrap, “U” wrap, perpendicular wrap, blind wrap, bridge split, and/or separated split).

The location constraints define hard and/or soft adjacencies (left, right, or either direction) and non-adjacencies for categories and/or category groups (referred to as “shops”) as well as proximities for trying to place defined categories as close as possible to another group of shops (referred to as “departments”) or points of interest without violating other constraints.

The grouping constraints define supported groupings of categories (e.g., the grouping of categories into shops), shop coherency (e.g., how shops should flow through a floorplan), and department coherency (e.g., how departments should be grouped together to decrease the change of department shops intermingling with each other).

The search engine 310 is configured to receive the request to generate a floorplan and/or one or more category placement parameters. The search engine 310 uses the request to generate a floorplan and/or one or more category placement parameters to obtain, from the database 315 (e.g., similar to databases 14; FIG. 1), one or more floorplan parameters. The floor parameters can include one or more of a location (e.g., a particular retail store, house, building, garden, office, or other physical location), a location size, a layout of a location, a quantity of fixtures at a location, types of fixtures at a location, distribution of the fixtures at a location (e.g., placement of the fixtures within a location), a current configuration of the fixture (e.g., shelf positions, fixture orientation, etc.), fixture characteristics (e.g., fixture size, fixture shape, etc.), and/or other fixture data. The database 315 stores historical floorplans, location data, fixture data, category placement parameters, floorplan parameters, and/or other data.

The search engine 310 is configured to provide the request to generate a floorplan, the one or more category placement parameters, the one or more floorplan parameters, other data from the database 315, and/or other data provided via the platform UI 305 to the floorplan generation module 320.

The floorplan generation module 320 is a category placement optimization engine that generates floorplans that account for a wide array of business requirements efficiently. In particular, the floorplan generation module 320 utilizes the one or more category placement parameters, the one or more floorplan parameters, other data from the database 315, and/or other data provided via the platform UI 305 (the “received inputs”) to generate floorplans that comply with the restrictions defined by the received inputs, identifies conflicting restrictions, resolves conflicts, and/or recommends solutions for resolving conflicts.

The floorplan generation module 320 provides the received inputs to the data transformation module 325. The data transformation module 325 transforms and/or formats the received inputs into one or more data sets or features that are used, in part, to generate floorplans. Example features include fixture adjacency, aisle data preparation, requested category, category fixture preference, category shop mapping, shop adjacency preference, stacking preference, sharing preference, etc. The data sets or features generated by the data transformation module 325 are provided to the constraint module 330 and the optimization module 335.

The constraint module 330 utilizes the data sets or features generated by the data transformation module 325 to preprocess hard constraints. The preprocess hard constraints are possible category placement options generated to (exponentially) reduce complexity, which improves performance of a floorplan generation computing device 4 (FIG. 1) by reducing an amount of computational resources utilized. The preprocess hard constraints applies constraints to the fixtures. In some embodiments, the constraint module 330 provides the preprocess hard constraints to the optimization module 335. In some embodiments, the preprocess hard constraints are used by a subset of the one or more modules of the optimization module 335. In some embodiments, the constraint module 330 generates the preprocess hard constraints while the optimization module 335 utilizes a subset of the one or more modules with the data sets or features generated by the data transformation module 325.

The optimization module 335 performs a multi-stage optimization procedure. The multi-stage optimization procedure can utilize one or more modules. In some embodiments, the one or more modules are nested. The nested modules (e.g., MILP1 through MILP3) can be utilized in sequence. Alternatively, in some embodiments, the one or more modules are used in parallel. In some embodiments, each module is configured to be utilized once (e.g., once per floorplan generation request, once per generated floorplan, or once per plurality of generated floorplan). In some embodiments, infeasibility errors in generated floorplans are detected early (e.g., after or during utilization of the first stage module 340 (MILP1)). As described below, detected infeasibility errors can be provided to users (e.g., via the platform UI 305) such that the users can diagnose and correct the infeasibility errors. By detecting errors early, the optimization module 335 recused the number of iterations performed by the floorplan generation computing device 4.

The first stage module 340 determines, based on the category placement parameter and the floorplan parameter, one or more floorplans. In some embodiments, the first stage module 340 determines, based on outputs of the data transformation module 325 and/or the constraint module 330, one or more floorplans. The one or more floorplans generated by the first stage module 340 are draft or initial floorplans are modified and/or updated by the second stage module 345 and/or the third stage module 350. The first stage module 340 is configured to generate floorplans with assigned categories to respective portions of a location represented by the floorplans. In particular, the first stage module 340 is configured to assign categories to fixtures without shop-related constraints. The first stage module 340 is configured to minimize wrapping and/or minimize stacking. The first stage module 340 constraints include assigning all categories with sufficient compatible contiguous space, forgo assigning categories in overlapping spaces, and satisfying adjacency and non-adjacency requirements for category pairs.

The floorplans generated by the first stage module 340 can be used to determine root causes of infeasibility. As described in detail below, infeasibility errors, when detected can cause the floorplan generation module 320 to cease generating floorplans (e.g., cease using the second and third stage modules 345 and 350). In some embodiments, infeasibility errors, when detected, cause the platform UI 305 to request updated category placement parameters and/or updated floorplan parameters that are used to generate updated floorplans (that resolve the infeasibility errors).

The second stage module 345 (MILP2), in accordance with a determination that a floorplan generated by the first stage module 340 satisfies a feasibility criteria threshold (e.g., infeasibility errors are not detected in a floorplan generated by the first stage module 340), determines a category group and/or adjacent category groups for the categories. The category group and the adjacent category groups are determined based on the category placement parameters, the floorplan parameters, and/or the floorplans generated by the first stage module 340. The second stage module 345 further determines, based on the category group and/or the adjacent category groups for the categories, modifications and/or updates to the floorplans generated by the first stage module 340. In particular, the second stage module 345 generates floorplans with an assigned category group and/or assigned adjacent category groups for the categories to modified and/or updated respective portions of the location represented by the floorplans. In other words, the second stage module 345 assigns shops to aisles considering shop-related objectives and constraints to the floorplans generated by the second stage module 345.

The second stage module 345 is configured to minimize wrapping and minimize stacking, as well as minimize number of aisles per shop, maximize shop connectivity, maximize shop coherence, maximize shop-to-shop adjacency, and/or maximize shop-to-shop coherence. The second stage module 345 includes the same constraints as the first stage module 340.

The third stage module 350 (MILP3) utilizes the floorplans generated by the second stage module 345 to optimize and/or improve the floorplans. The third stage module 350 determines, based on the category placement parameter, the floorplan parameter, and/or the floorplans generated by the second stage module 345, optimized and/or improved floorplans. The optimized and/or improved floorplans assigs the category group and/or the adjacent category groups for the categories to new respective portions of the location represented by the optimized and/or improved floorplans. The new respective portions of the location represented by the optimized and/or improved floorplans optimize placement of the category group and/or the adjacent category groups. In other words, the third stage module 350 finalizes assignment of categories to fixtures with minimal deviation from aisle assignments of second stage module 345. In some embodiments, the third stage module 350 is a superset of the second stage module 345.

The third stage module 350 is configured to minimize wrapping and minimize stacking, minimize number of aisles per shop, maximize shop connectivity, maximize shop coherence, maximize shop-to-shop adjacency, and/or maximize shop-to-shop coherence, as well as minimize changes in shop-aisle assignments as determined by the second stage module 345. The third stage module 350 includes the same constraints as the first stage module 340 and the second stage modules 345.

The infeasibility detection module 355 in configured to detect one or more infeasibility errors in generated floorplans. In some embodiments, the infeasibility detection module 355 detects one or more infeasibility errors based on the category placement parameter and/or the floorplan parameter. Alternatively, or in addition, in some embodiments, the infeasibility detection module 355 detects one or more infeasibility errors based on the outputs of the constraint module 330 and/or the data transformation module 325. In some embodiments, the infeasibility detection module 355 is an infeasibility MILP that identifies a root cause and/or solutions for the infeasibility. For example, the infeasibility detection module 355 can detect when there may not be sufficient space to place all the categories in the floorplan, and provide one or more possible reasons, such as not enough space in compatible fixtures and aggressive space requirements for the category. The infeasibility detection module 355 finds solutions by changing category widths to make the floorplan feasible. An objective of the infeasibility detection module 355 is to minimize space shortage and utilizes constraints used by the first stage module 340.

The infeasibility detection module 355 presents the detected infeasibility errors to users via the platform UI 305. The infeasibility errors presented at the platform UI 305 allow users to diagnose and correct the infeasibility errors. For example, in accordance with a determination that a floorplan satisfies an infeasibility criteria threshold, the infeasibility detection module 355 causes a user device to present an error notification that identifies an infeasibility error in the category placement parameter and/or the floorplan parameter. In some embodiments, the infeasibility detection module 355 provides an explanation for the infeasibility errors and/or recommend one or more solutions for resolving the infeasibility errors. For example, if a fixture size at a portion of a location cannot accommodate a category, the infeasibility detection module 355 can indicate that a needed fixture is unavailable and/or recommend another portion of the location that includes a fixture for accommodating the category. In some embodiments, the infeasibility detection module 355 requests, from the user device, an updated category placement parameter and/or an updated floorplan parameter.

In some embodiments, the infeasibility detection module 355 detects infeasibility errors while the first stage module 340 determines one or more floorplans. Alternatively, or in addition, in some embodiments, the infeasibility detection module 355 detects infeasibility errors after the first stage module 340 determines the one or more floorplans. This allows the floorplan generation system 300 to identify infeasibility errors early on, which improves the user experience, reduces the need of engineer supervision, and accelerates adoption of generated floorplans.

In some embodiments, the floorplan generation module 320 determines floorplan scores for the generated floorplans. The floorplan scores indicate how many constraints were satisfied. More specifically, the floorplan score is determined based on metrics that measure a degree to which different business requirements are met (e.g., actual results against requested constraints). Floorplan scored can be determined for floorplan generated by the floorplan generation module 320 and/or floorplans manually generated by a user. In some embodiments, a floorplan score is generated for each category assigned within a floorplan. The floorplan scores are presented to the users via the platform UI 305. The floorplan scores allow users to select a floorplan that satisfies their desired criteria or constraints.

In some embodiments, the floorplan generation module 320 causes a user device to present, via the platform UI 305, the generated floorplans. In some embodiments, each floorplan is presented with an associated floorplan score. In some embodiments, the floorplan generation module 320 request the user to select, via the platform UI 305, a floorplan. In some embodiments, the floorplan generation module 320 prompts the user to approve a floorplan, deploy a floorplan, or modify a floorplan (e.g., manually edit portions of a floorplan or provide modified category placement parameters and/or modified floorplan parameters).

In some embodiments, the floorplan generation system 300, in response to a user request to approve and/or deploy a floorplan, distributes the floorplan to one or more locations. In some embodiments, deployed floorplans are presented with a status, scope of change, change strategy, etc. Example data presented with the floorplans is shown below in reference to FIG. 5. In some embodiments, the floorplan generation system 300 is communicatively coupled with an automated robotic device (e.g., an autonomous forklift, autonomous reshelving robot, etc.). In some embodiments, the floorplan generation system 300, in response to a user request to approve and/or deploy a floorplan, provides the floorplan to the autonomous robotic device. The autonomous robotic device, in response to receiving the floorplan, distributes one or more categories or category groups (e.g., to respective portions of the location and/or fixtures within a location).

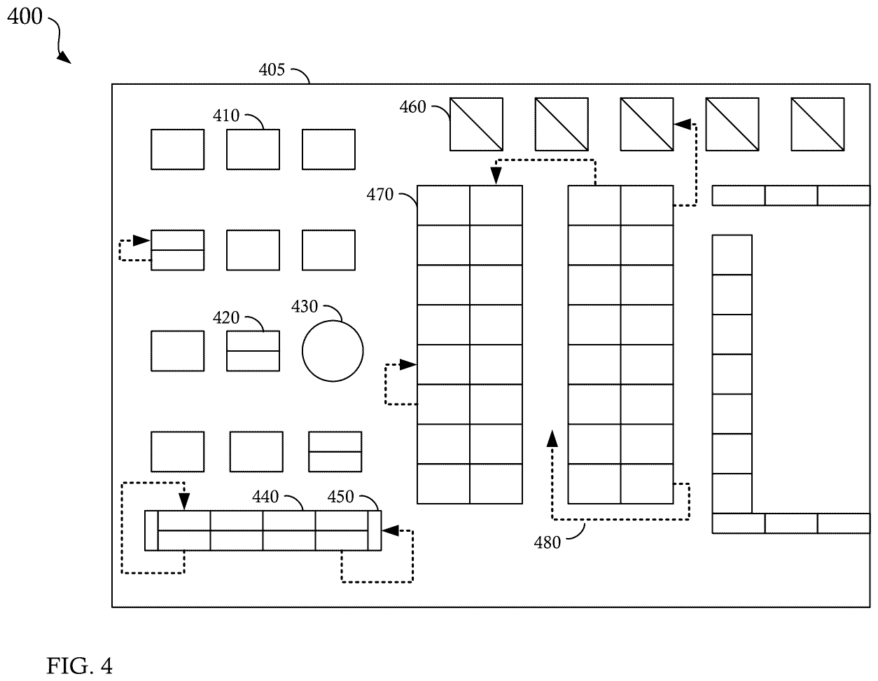

FIG. 4 illustrates an example floorplan, in accordance with some embodiments. The example floorplan 400 identifies a location 405 and one or more fixtures within the location. The one or more fixtures can include different fixture types. For example, as shown in FIG. 4, the location 405 includes a first fixture type 410, a second fixture type 420, a third fixture type 430, a fourth fixture type 440, a fifth fixture type 450, a sixth fixture type 460, a seventh fixture type 470, etc. The example floorplan 400 shows different wraps and/or splits. The different wraps and/or splits are represented by dotted arrows 480. Each of the fixture is assigned a category, category group, or group of category groups.

FIG. 5 illustrates an example floorplan user interface for a floorplan generation system, in accordance with some embodiments. The example floorplan UI 500 includes a relay title 503, an edit relay UI element 505, a delete relay UI element 507, an export relay UI element 509, relay detail 515, relay strategies information 520. The relay detail 515 can include information on one or more relay strategies. For example, the relay detail 515 includes additional information of the “All Stores” strategy 514. As described above, to minimize changes to current floorplans and/or complete overhauls, floorplans are generated via one or more relay.

In some embodiments, a relay is applied to one or more locations (e.g., stores). In some embodiments, a status of the relays is shown via the example floorplan UI 500. For example, relay “Strategy 3” is applied to 10 stores and less than all of the 10 stores successfully implemented the relay. The different status include exported, approved, successful, manual edit, unsuccessful, pending, unsubmitted, etc. In some embodiments, a relay is provided to an autonomous robotic device such that the autonomous robotic, upon receiving the relay, applies one or more floorplan changes defined in the relay. In some embodiments, a relay can be sent to an autonomous robotic device and/or other computing devices via the export relay UI element 509.

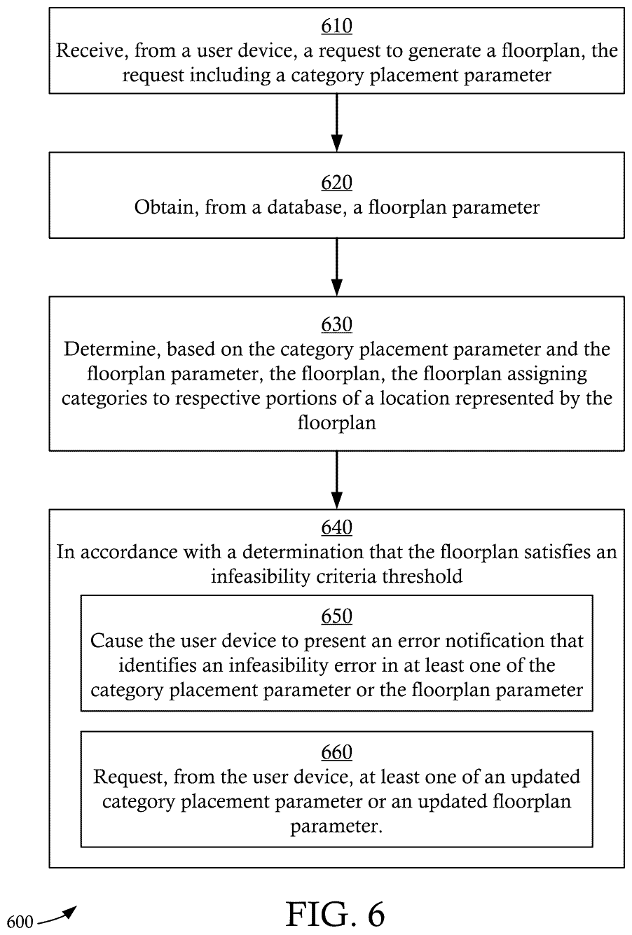

FIG. 6 is a flowchart illustrating a floorplan generation method, in accordance with some embodiments. The floorplan generation method 600 shows various steps of the method. Although embodiments are discussed herein including application of certain steps and/or processes, it will be appreciated that various elements of the floorplan generation method 600 may be performed in various orders and/or performed by additional and/or alternative processes or system elements as those disclosed herein. The steps of the method 600 can be performed by one or more processors (e.g., CPUs, GPUs, etc.) of a system (e.g., a floorplan generation computing device 4 or any other device described above in reference to FIG. 1). At least some of the operations shown in FIG. 6 correspond to instructions stored in a computer memory or computer-readable storage medium (e.g., storage, RAM, and/or memory). Operations of the method 600 can be performed by a single device alone or in conjunction with one or more processors and/or hardware components of another communicatively coupled device and/or instructions stored in memory or computer-readable medium of the other device communicatively coupled to the system. In some embodiments, the various steps of the method 600 described herein are interchangeable and/or optional, and respective steps of the methods 600 are performed by any of the aforementioned devices, systems, or combination of devices and/or systems. For convenience, the method steps will be described below as being performed by particular component or device (e.g., the floorplan generation computing device 4), but should not be construed as limiting the performance of the operation to the particular device in all embodiments.

At step (610), the method 600 include receiving, from a user device, a request to generate a floorplan, the request including one or more category placement parameters. At step (620), the method 600 includes obtaining, from a database, one or more floorplan parameters. At step (630), the method 600 includes determining, based on the one or more category placement parameters and the one or more floorplan parameters, the floorplan. The floorplan assigns categories to respective portions of a location represented by the floorplan. At step (640), the method 600 includes, in accordance with a determination that the floorplan satisfies an infeasibility criteria threshold, causing (650) the user device to present an error notification that identifies an infeasibility error in at least one of the one or more category placement parameters and/or the one or more floorplan parameters and requesting (660), from the user device, at least one of one or more updated category placement parameters and/or one or more updated floorplan parameters. For example, as described above in reference to FIG. 3, infeasibility errors can be detected during and/or after the first stage module 340. In some embodiments, the infeasibility criteria threshold is a predetermined number of infeasibility errors (e.g., 1 infeasibility error, 3 infeasibility errors, 7 infeasibility errors, etc.) equal to or greater than an infeasibility baseline (e.g., 1 infeasibility error, 2 infeasibility errors, etc.) Alternatively, or in addition, the infeasibility criteria threshold is an infeasibility type, such a fixture incompatibility, location size incompatibility, category placement parameter incompatibility, and/or floorplan parameter incompatibility.

In some embodiments, the respective portions of the location represented by the floorplan are first respective portions of the location represented by the floorplan, the floorplan is a first floorplan, and the method 600 includes, in accordance with a determination that the first floorplan satisfies a feasibility criteria threshold, determines at least one of a category group and/or adjacent category groups for the categories and determines, based on the at least one of the category group and/or the adjacent category groups for the categories, a second floorplan. The category group and the adjacent category groups are determined based on the category placement parameter, the floorplan parameter, and/or the first floorplan. The second floorplan assigns the least one of the category group and the adjacent category groups for the categories to second respective portions of the location represented by a second floorplan. The method 600 further includes causing the user device to present the second floorplan; and requesting, from the user device, an approval input, a rejection input, or a modification input. For example, as described above in reference to FIG. 3, when infeasibility errors are not detected the second stage module 345 is applied to at least the first floorplan. In some embodiments, the feasibility criteria threshold is a predetermined number of infeasibility errors (e.g., 1 infeasibility error, 3 infeasibility errors, 7 infeasibility errors, etc.) equal to or less than a feasibility baseline (e.g., 1 infeasibility error, 2 infeasibility errors, etc.) Alternatively, or in addition, the feasibility criteria threshold is an infeasibility type, such a fixture incompatibility, location size incompatibility, category placement parameter incompatibility, and/or floorplan parameter incompatibility.

In some embodiments, the method 600 further includes, after determining the second floorplan, determining, based on at least one of the category placement parameter; the floorplan parameter; and/or the second floorplan, a third floorplan. The third floorplan assigns the at least one of the category group and/or the adjacent category groups for the categories to third respective portions of the location represented by the third floorplan. The third respective portions of the location represented by the third floorplan optimizing placement of the category group and/or the adjacent category groups. The method 600 further includes causing the user device to present the third floorplan. For example, as described above in reference to FIG. 3, the third stage module 350 is applied to at least the second floorplan generated by the second stage module 345.

In some embodiments, causing the user device to present the second floorplan includes causing the user device to present a fourth floorplan in conjunction with the second floorplan, and the method 600 further includes requesting, from the user device, selection of the second floorplan or the fourth floorplan.

In some embodiments, the modification input includes at least one of one or more modified category placement parameters and/or one or more modified floorplan parameters and the method 600 further includes, in response to receiving the modification input, determining, based on the one or more modified category placement parameters and the one or more modified floorplan parameters, a fifth floorplan that assigns the categories to fifth respective portions of the location represented by the fifth floorplan.

In some embodiments, the method 600 further includes, after determining the second floorplan, determining a floorplan score and causing the user device to present the floorplan score with the second floorplan.

In some embodiments, the method 600 further includes, in response to receiving the approval input, initiating deployment of the second floorplan at the location and causing the user device to present a deployment status of the second floorplan at the location.

In some embodiments, the method 600 further includes, in response to receiving the approval input, providing the second floorplan to an autonomous robotic device and causing the autonomous robotic device to distribute the categories based on the second floorplan.

In some embodiments, the method 600 further includes, in response to receiving at least one of the one or more updated category placement parameters and/or the one or more updated floorplan parameters, determining, based on the at least one of the one or more updated category placements parameter and/or the one or more updated floorplan parameters, a sixth floorplan that assigns the categories to sixth respective portions of the location represented by the sixth floorplan.

In some embodiments, the category placement parameter includes one or more of a category, a category constraint, a fixture constraint, a scope of change, an environmental constraint, a category grouping constraint, a movement constraint, or a location constraint.

In some embodiments, the floorplan parameter includes one or more of a store size, a quantity of fixtures, fixture locations, and fixture characteristics.

In accordance with some embodiments, a non-transitory computer readable storage medium including instructions that, when executed by a computing device, cause the computer device to perform steps corresponding to method 600.

In accordance with some embodiments, a system including a floorplan generation computing device 4, a user device, and/or other device describe above in FIG. 1, the system configured to perform the steps of method 600.

In accordance with some embodiments, a computing device (e.g., a floorplan generation computing device 4, a user device, and/or other device describe above in FIG. 1) configured to perform the steps of method 600.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a user device;
a database;
a computing device communicatively coupled with the user device and the database, the computing device configured to:
receive, from the user device, a request to generate a floorplan, the request including a category placement parameter;
obtain, from the database, a floorplan parameter;
determine, based on the category placement parameter and the floorplan parameter, the floorplan, wherein the floorplan assigns categories to respective portions of a location represented by the floorplan;
in accordance with a determination that the floorplan satisfies an infeasibility criteria threshold:
cause the user device to present an error notification that identifies an infeasibility error in at least one of the category placement parameter or the floorplan parameter, and
request, from the user device, at least one of an updated category placement parameter or an updated floorplan parameter.

2. The system of claim 1, wherein the respective portions of the location represented by the floorplan are first respective portions of the location represented by the floorplan, the floorplan is a first floorplan, and the computing device is further configured to:
in accordance with a determination that the first floorplan satisfies a feasibility criteria threshold:
determine at least one of a category group and adjacent category groups for the categories, wherein the category group and the adjacent category groups are determined based on the category placement parameter, the floorplan parameter, and the first floorplan;
determine, based on the at least one of the category group and the adjacent category groups for the categories, a second floorplan, wherein the second floorplan assigns the least one of the category group and the adjacent category groups for the categories to second respective portions of the location represented by a second floorplan;
cause the user device to present the second floorplan; and
request, from the user device, an approval input, a rejection input, or a modification input.

3. The system of claim 2, wherein the computing device is further configured to:
after determining the second floorplan:
determine, based on at least one of the category placement parameter, the floorplan parameter, and the second floorplan, a third floorplan, wherein the third floorplan assigns the at least one of the category group and the adjacent category groups for the categories to third respective portions of the location represented by the third floorplan, the third respective portions of the location represented by the third floorplan optimizing placement of the category group and the adjacent category groups; and
cause the user device to present the third floorplan.

4. The system of claim 2, wherein causing the user device to present the second floorplan includes causing the user device to present a fourth floorplan in conjunction with the second floorplan, and the computing device is further configured to:
request, from the user device, selection of the second floorplan or the fourth floorplan.

5. The system of claim 2, wherein the modification input includes at least one of a modified category placement parameter or a modified floorplan parameter and the computing device is further configured to:
in response to receiving the modification input, determine, based on the modified category placement parameter and the modified floorplan parameter, a fifth floorplan that assigns the categories to fifth respective portions of the location represented by the fifth floorplan.

6. The system of claim 2, wherein the computing device is further configured to:
after determining the second floorplan, determine a floorplan score; and
cause the user device to present the floorplan score with the second floorplan.

7. The system of claim 2, wherein the computing device is further configured to:
in response to receiving the approval input, initiate deployment of the second floorplan at the location; and
cause the user device to present a deployment status of the second floorplan at the location.

8. The system of claim 2, wherein system further comprises:
an autonomous robotic device,
wherein the computing device is further configured to:
in response to receiving the approval input, provide the second floorplan to the autonomous robotic device; and
cause the autonomous robotic device to distribute the categories based on the second floorplan.

9. The system of claim 1, wherein the computing device is further configured to:
in response to receiving at least one of the updated category placement parameter or the updated floorplan parameter, determine, based on the at least one of the updated category placement parameter or the updated floorplan parameter, a sixth floorplan that assigns the categories to sixth respective portions of the location represented by the sixth floorplan.

10. The system of claim 1, wherein the category placement parameter includes one or more of a category, a category constraint, a fixture constraint, a scope of change, an environmental constraint, a category grouping constraint, a movement constraint, or a location constraint.

11. The system of claim 1, wherein the floorplan parameter includes one or more of a store size, a quantity of fixtures, fixture locations, and fixture characteristics.

12. A computer-implemented method, comprising:
receiving, from a user device, a request to generate a floorplan, the request including a category placement parameter;
obtaining, from a database, a floorplan parameter;
determining, based on the category placement parameter and the floorplan parameter, the floorplan, wherein the floorplan assigns categories to respective portions of a location represented by the floorplan;
in accordance with a determination that the floorplan satisfies an infeasibility criteria threshold:
causing the user device to present an error notification that identifies an infeasibility error in at least one of the category placement parameter and the floorplan parameter, and
requesting, from the user device, at least one of an updated category placement parameter or an updated floorplan parameter.

13. The computer-implemented method of claim 12, wherein the respective portions of the location represented by the floorplan are first respective portions of the location represented by the floorplan, the floorplan is a first floorplan, and the computer-implemented method further comprises:
in accordance with a determination that the first floorplan satisfies a feasibility criteria threshold:
determining at least one of a category group and adjacent category groups for the categories, wherein the category group and the adjacent category groups are determined based on the category placement parameter, the floorplan parameter, and the first floorplan;
determining, based on the at least one of the category group and the adjacent category groups for the categories, a second floorplan, wherein the second floorplan assigns the least one of the category group and the adjacent category groups for the categories to second respective portions of the location represented by a second floorplan;
causing the user device to present the second floorplan; and
requesting, from the user device, an approval input, a rejection input, or a modification input.

14. The computer-implemented method of claim 13, wherein the computer-implemented method further comprises:
after determining the second floorplan:
determining, based on at least one of the category placement parameter, the floorplan parameter, and the second floorplan, a third floorplan, wherein the third floorplan assigns the at least one of the category group and the adjacent category groups for the categories to third respective portions of the location represented by the third floorplan, the third respective portions of the location represented by the third floorplan optimizing placement of the category group and the adjacent category groups; and
causing the user device to present the third floorplan.

15. The computer-implemented method of claim 13, wherein causing the user device to present the second floorplan includes causing the user device to present a fourth floorplan in conjunction with the second floorplan, and the computer-implemented method further comprises:
request, from the user device, selection of the second floorplan or the fourth floorplan.

16. The computer-implemented method of claim 13, wherein the modification input includes at least one of a modified category placement parameter or a modified floorplan parameter and the computer-implemented method further comprises:
in response to receiving the modification input, determining, based on the modified category placement parameter and the modified floorplan parameter, a fifth floorplan that assigns the categories to fifth respective portions of the location represented by the fifth floorplan.

17. A non-transitory computer readable medium having instructions stored thereon, wherein the instructions, when executed by at least one processor, cause at least one device to perform operations comprising:
receiving, from a user device, a request to generate a floorplan, the request including a category placement parameter;
obtaining, from a database, a floorplan parameter;
determining, based on the category placement parameter and the floorplan parameter, the floorplan, wherein the floorplan assigns categories to respective portions of a location represented by the floorplan;
in accordance with a determination that the floorplan satisfies an infeasibility criteria threshold:
causing the user device to present an error notification that identifies an infeasibility error in at least one of the category placement parameter and the floorplan parameter, and
requesting, from the user device, at least one of an updated category placement parameter or an updated floorplan parameter.

18. The non-transitory computer readable medium of claim 17, wherein the respective portions of the location represented by the floorplan are first respective portions of the location represented by the floorplan, the floorplan is a first floorplan, and the instructions, when executed by the at least one processor, further cause the at least one device to perform operations comprising:
in accordance with a determination that the first floorplan satisfies a feasibility criteria threshold:
determining at least one of a category group and adjacent category groups for the categories, wherein the category group and the adjacent category groups are determined based on the category placement parameter, the floorplan parameter, and the first floorplan;
determining, based on the at least one of the category group and the adjacent category groups for the categories, a second floorplan, wherein the second floorplan assigns the least one of the category group and the adjacent category groups for the categories to second respective portions of the location represented by a second floorplan;
causing the user device to present the second floorplan; and
requesting, from the user device, an approval input, a rejection input, or a modification input.

19. The non-transitory computer readable medium of claim 18, wherein the instructions, when executed by the at least one processor, further cause the at least one device to perform operations comprising:
after determining the second floorplan:
determining, based on at least one of the category placement parameter, the floorplan parameter, and the second floorplan, a third floorplan, wherein the third floorplan assigns the at least one of the category group and the adjacent category groups for the categories to third respective portions of the location represented by the third floorplan, the third respective portions of the location represented by the third floorplan optimizing placement of the category group and the adjacent category groups; and
causing the user device to present the third floorplan.

20. The non-transitory computer readable medium of claim 18, wherein causing the user device to present the second floorplan includes causing the user device to present a fourth floorplan in conjunction with the second floorplan, and the instructions, when executed by the at least one processor, further cause the at least one device to perform operations comprising:
request, from the user device, selection of the second floorplan or the fourth floorplan.
